(19) United States
(12) Patent Application Publication
(10) Pub. No.: US 2015/0213639 A1
(43) Pub. Date: Jul. 30, 2015

(54) IMAGE GENERATION APPARATUS AND PROGRAM

(71) Applicant: National Cancer Center, Tokyo (JP)

(72) Inventor: Teiji Nishio, Tokyo (JP)

(21) Appl. No.: 14/426,519

(22) PCT Filed: Sep. 4, 2013
(86) PCT No.: PCT/JP2013/073801

§ 371 Date: Mar. 6, 2015

(30) Foreign Application Priority Data
Sep. 7, 2012 (JP) 2012-197917

(51) Int. Cl. G06T 15/08; G06T 11/00

(52) U.S. Cl. CPC G06T 15/08; G06T 11/008; G06T 2211/416; G06T 2207/10081

(57) ABSTRACT

To provide an image generation apparatus and a program capable of generating an image of a region of interest broken at any selected sectional plane. Reconstructed image voxel data in a three-dimensional space is received. Designation of two-dimensional regions of interest is received on a plurality of sectional planes of the image voxel data. At least one three-dimensional region of interest corresponding to the two-dimensional regions of interest is generated in the three-dimensional space, on the basis of the designated two-dimensional regions of interest. A contour is generated using region-of-interest voxel data which corresponds to the received image voxel data and has a voxel value which is made different depending on whether or not the region-of-interest voxel data is included in at least one three-dimensional region of interest. The contour is drawn together with the image voxel data included in the defined plane.

### TECHNICAL FIELD

The present disclosure relates to an image generation apparatus which processes an image reconstructed from a tomographic image.

### BACKGROUND ART

Reconstructing a three-dimensional image of the inside of an object from a plurality of tomographic images of the object, by Computer Tomography (CT), etc., has been widely performed.

The reconstructed three-dimensional image is expressed as voxel values (three dimensionally arranged pixel value data) arranged in a predetermined coordinate system. There is a technology of performing three-dimensional display, by comparing the voxel value with a predetermined threshold value, geometrically modelling the voxel extracted as surface data as a result of the comparison, and calculating the reflectance when the modelled image is externally irradiated with light on the basis of the distance and the angle relative to the light source of the irradiated light (non-patent document 1).

### PRIOR ARTS

### Non-Patent Document

Basic of Creating 3D-CT Image, Yasunobu FUKUNISHI, Journal of Japanese Society of Radiological Technology Kinki Branch, Japan, September, 2007, Vol. 13, No. 2, pages 20-29

### SUMMARY

However, according to the prior arts, although a three-dimensional structure of the inside of the object can be recognized, the detailed inside structure cannot be visible. Thus, displaying with tomographic images from which the reconstructed image has been created, may be thought of. However, for example, for a medical use, when a region of interest (ROI: Region Of Interest) such as an affected area is set, the region of interest does not always spread in the tomographic direction. Therefore, the inside status may not be easily understood from the external image of a tissue or a tomographic image of the tissue in a predetermined direction.

Further, if the region of interest is made visible at any selected sectional plane by breaking the voxel at the selected sectional plane, because the region of interest is set for each voxel, jaggies may be caused on the contour of the region of interest, in some sectional planes. Therefore, understanding the image is not easy, either.

The present disclosure has been thought of, in view of the above drawbacks. One of the objectives of the present disclosure is to provide an image generation apparatus and a program capable of generating an image of a region of interest broken in any selected sectional plane.

In to order solve the drawbacks of the above prior arts, the present disclosure provides an image generation apparatus comprising, an image receiving device which receives image voxel data in a three-dimensional space reconstructed from a plurality of tomographic images, a designation receiving device which displays an image expressed by voxel data included in the image voxel data and located on a plurality of planes, and receives designation of at least one two-dimensional region of interest on the image, a device which generates at least one three-dimensional region of interest corresponding to the two-dimensional region of interest in the three-dimensional space, on the basis of each designated two-dimensional region of interest, a storage device which stores region-of-interest voxel data corresponding to the received image voxel data, and having a voxel value which is made different depending on whether or not the region-of-interest voxel data is included in at least one three-dimensional region of interest, a contour generation device which receives information defining a plane in the three-dimensional space, reads out region-of-interest voxel data included in the plane from the storage device, and generates a contour expressing the boundary of the region-of-interest voxel data, and a drawing device which draws the generated contour together with the image voxel data included in the defined plane.

According to the present disclosure, an image of a region of interest broken at any selected sectional plane can be generated.

### BRIEF DESCRIPTION OF THE DRAWINGS

FIG. 1 is a block diagram showing a constitutional example of an image generation apparatus according to an embodiment of the present disclosure.

FIG. 2 is a functional block diagram showing an example of an image generation apparatus according to an embodiment of the present disclosure.

FIG. 3 is an explanatory view showing an arrangement example on a plane of voxel data to be processed by an image generation apparatus according to an embodiment of the present disclosure, and a contour set to pass through the inside of the arranged voxels.

FIG. 4 is an explanatory view showing an arrangement example on a designated plane of voxel data to be processed by an image generation apparatus according to an embodiment of the present disclosure.

FIG. 5A is an explanatory view showing an example of a contour generation process by an image generation apparatus according to an embodiment of the present disclosure.

FIG. 5B is an explanatory view showing an example of a contour generation process by an image generation apparatus according to an embodiment of the present disclosure.

FIG. 5C is an explanatory view showing an example of a contour generation process by an image generation apparatus according to an embodiment of the present disclosure.

FIG. 5D is an explanatory view showing an example of a contour generation process by an image generation apparatus according to an embodiment of the present disclosure.

FIG. 5E is an explanatory view showing an example of a contour generation process by an image generation apparatus according to an embodiment of the present disclosure.

FIG. 6C is another explanatory view showing an example of a contour generation process by an image generation apparatus according to an embodiment of the present disclosure.

FIG. 6D is another explanatory view showing an example of a contour generation process by an image generation apparatus according to an embodiment of the present disclosure.

FIG. 6E is another explanatory view showing an example of a contour generation process by an image generation apparatus according to an embodiment of the present disclosure.

FIG. 7 is an explanatory view showing a specific example of a contour generation process by an image generation apparatus according to an embodiment of the present disclosure.

### EMBODIMENT

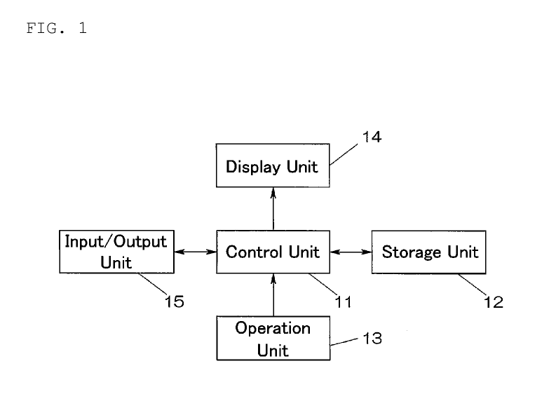

An embodiment of the present disclosure will be explained with reference to the drawings. As exemplified in FIG. 1, an image generation apparatus according to an embodiment of the present disclosure comprises a control unit 11, a storage unit 12, an operation unit 13, a display unit 14, and an input/output unit 15.

The control unit 11 is a program-controlled device such as a CPU, and operates in accordance with a program stored in the storage unit 12. According to the present embodiment, control unit 11 receives, through the input/output unit 15, image voxel data in a three-dimensional space, reconstructed from a plurality of tomographic images. Further, the control unit 11 receives designation of at least one two-dimensional region of interest on the tomographic image, and generates at least one three-dimensional region of interest corresponding to the two-dimensional region of interest in the three-dimensional space, on the basis of each designated two-dimensional region of interest. The control unit 11 generates region-of-interest voxel data which corresponds to the received image voxel data and stores the generated region-of-interest voxel data in the storage unit 12. The voxel value of the region-of-interest voxel data is made different depending on whether or not the region-of-interest voxel data is included in the at least one three-dimensional region of interest. In addition, the control unit 11 receives information defining a plane in the three-dimensional space, reads out region-of-interest voxel data included in the plane from the storage unit 12, generates a contour representing the boundary of the region-of-interest voxel data, and outputs an image drawn to have the generated contour together with the image voxel data included in the defined plane, to the display unit 14. The detailed process of the control unit 11 will be described below.

The storage unit 12 is a memory device, etc., and stores a program to be executed by the control unit 11. The program may be stored in a computer readable recording medium such as a DVD-ROM, etc., and copied to the storage unit 12. The storage unit 12 also operates as a work memory of the control unit 11.

The operation unit 13 comprises a mouse, a keyboard, etc. The operation unit 13 accepts an operation by a user, and outputs information representing the content of the operation to the control unit 11. The display unit 14 is a display, etc., which outputs and displays instructed information on a display, in response to the instructions input from the control unit 11. The input/output unit 15 is an USB interface, etc., which receives the three-dimensional reconstructed image generated on the basis of the tomographic images captured by, for example, a CT apparatus, and outputs the received three-dimensional reconstructed image to the control unit 11.

In the present embodiment, the control unit 11 functionally realizes the structure exemplified in FIG. 2 by executing the program stored in the storage unit 12. The control unit 11 functionally comprises an image receiving unit 21, a designation receiving unit 22, a region generation unit 23, a data storage unit 24, a contour generation unit 25, and a drawing unit 26.

The image receiving unit 21 receives, through the input/output unit 15, a three-dimensional reconstructed image reconstructed from a plurality of tomographic images, and stores the received three-dimensional reconstructed image in the storage unit 12. Here, the three-dimensional reconstructed image is, for example, virtual pixels three dimensionally arranged in the X-, Y-, and Z-axis directions which are perpendicular with each other (image voxel data). In the following explanation, the tomographic images are captured in the plane defined by the X-axis and the Y-axis. Namely, the three-dimensional reconstructed image is reconstructed on the basis of tomographic images captured at mutually different positions in the Z-axis direction. When the object is a human body, and tomographic images parallel with the cross-sectional plane are obtained, the Z-axis may be defined as an axis extending from the top of his/her head to his/her feet (line of intersection between the sagittal plane and the coronal plane), the Y-axis may be defined as the front/back direction of the human body, and the X-axis may be defined as the right/left direction of the human body.

The designation receiving unit 22 extracts a voxel data group arranged in a predetermined XY-plane, YZ-plane, or XZ-plane, from the image voxel data stored in the storage unit 12, and outputs and displays an image represented by the voxel data group on the display unit 14. Further, the designation receiving unit 22 receives the designation of a two-dimensional region of interest on the displayed image. Specifically, the designation receiving unit 22 selects a plane to be displayed, in response to the instruction by the user. Then, an image expressed by the voxel data group arranged on the selected plane is displayed on the display unit 14. When the user designates a plurality of points on the displayed image, by clicking with a mouse, and the like, the designation receiving unit 22 stores the designated plurality of points in the storage unit 12, and sets a region surrounded by each closed curve formed by connecting the plurality of points, as a two-dimensional region of interest on the displayed image.

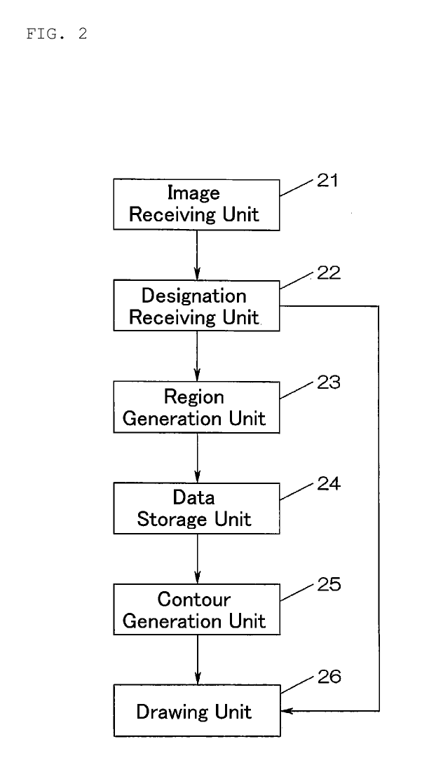

One of the characteristic features of the present embodiment is that a boundary line (closed curve) of the two-dimensional region of interest can be set regardless of the position of the voxel. Specifically, the closed curve defining the two-dimensional region of interest does not extend along the boundary line of the voxel (voxel periphery), but, in general, passes through the inside of the voxels located at the boundary of the two-dimensional region of interest (FIG. 3). FIG. 3 shows the state that (a part of) the closed curve passes through the inside of the voxels B13, B22, B23, B32, . . . . For a method for setting such a two-dimensional region of interest, other widely known various methods for designating an image region, such as a method for drawing a curve using a mouse, etc., may be applied.

The region generation unit 23 forms a three-dimensional region of interest by connecting the two-dimensional regions of interest set on the tomographic image (three-dimensional region of interest corresponding to two-dimensional regions of interest). The detailed explanation regarding the method for generating the boundary plane of the three-dimensional region is omitted here, because the boundary plane of the three-dimensional region may be generated by, for example, applying a method widely known in the modeling of three-dimensional computer graphics, wherein a three-dimensional shape having a closed curve defining a two-dimensional region of interest as a cross-section at each position in the Z-axis direction, is generated (such as a method usually referred to as variable section sweep, etc.). If there are a plurality of two-dimensional regions of interest which cannot be included in one three-dimensional region (the positions of which do not overlap with each other), the three-dimensional region of interest is generated for each of the two-dimensional region of interest groups which do not overlap with each other.

The data storage unit 24 holds an area for storing region-of-interest voxel data in the storage unit 12, the region-of-interest voxel data having voxels arranged therein, the number and the arrangement positions of the voxels being the same as the number and the arrangement positions of the voxels in the image voxel data in the three-dimensional space received by the image receiving unit 21. In the region-of-interest voxel data, the voxel located within the three-dimensional region of interest formed by the region generation unit 23 has a voxel value Vint, whereas the voxel located outside of the three-dimensional region of interest has a voxel value Vext, Vext being different from Vint. Further, the data storage unit 24 sets the voxel value of the voxel, in the region-of-interest voxel data, having the boundary of the three-dimensional region of interest (closed curve of the two-dimensional region of interest) passing therethrough, as described below.

Namely, in the region-of-interest voxel data, with respect to the voxel adjacent to both the voxel having the voxel value Vint and the voxel having the voxel value Vext, the data storage unit 24 sets the voxel value between Vext representing the location outside of the three-dimensional region of interest and Vint representing the location within the three-dimensional region of interest, corresponding to the distance from the relevant voxel (hereinbelow, referred to as a boundary voxel) to the boundary of the three-dimensional region of interest.

As an example, with respect to the boundary voxel, the data storage unit 24 selects a vertex included in the three-dimensional region of interest from among the vertexes of the boundary voxel, and obtains the distance from the position coordinate of the selected vertex to the boundary of the three-dimensional region of interest. When there are a plurality of vertexes included in the three-dimensional region of interest, distances from the position coordinates of the respective vertexes to the boundary of the three-dimensional region of interest are obtained, and the maximum distance thereamong is used as the distance.

The distance can be calculated as the minimum distance (Euclidean distance) between the boundary plane of the three-dimensional region of interest and the vertex position coordinate of the boundary voxel, but the calculation may be simplified. Specifically, the data storage unit 24 obtains the sectional plane regarding the boundary of the three-dimensional region of interest on the XY-plane (Z=Zc) including the vertex position coordinate (Xc, Yc, Zc) of the boundary voxel (sectional plane regarding the boundary of the three-dimensional region of interest at the position Zc). This sectional plane corresponds to a closed curve in the XY-plane. Then, the length of the perpendicular line extending from the vertex position coordinate (Xc, c) of the boundary voxel in the XY-plane to the obtained closed curve may be used as the distance from the vertex position coordinate of the boundary voxel to the boundary of the three-dimensional region of interest.

The contour generation unit 25 receives information which defines a virtual plane designated by the user through the operation of the operation unit 13, in the three-dimensional space. Detailed explanation regarding the method for this plane designation is omitted here, because a method widely used in the three-dimensional computer graphics technology can be applied for this method. The contour generation unit 25 reads out the region-of-interest voxel data included in the designated plane, from the storage unit 12, and generates a contour image expressing the boundary of the region-of-interest voxel data. The region-of-interest voxel data included in the plane is a set of voxel data pieces two-dimensionally arranged in vertical and lateral directions within the plane, as exemplified in FIG. 4. Hereinbelow, the voxel located at ξ-th (ξ=1, 2, . . . ) from the left and η-th (η=1, 2, . . . ) from the top within the plane, is written as B(ξ, η).

The contour generation unit 25 sequentially selects, from the set of voxels arranged within the plane, a set (small set) of 2×2 voxel data pieces adjacent to each other, i.e., {B (ξ, η), B(ξ+1, η), B(ξ, η+1), B(ξ+1, η+1)}, in a predetermined order. Here, the predetermined order starts from a 2×2 voxel data set {B(0, 0), B(1, 0), B(0, 1), B(1, 1)} having B(0, 0) at the upper-left end, and {B(1, 0), B(2, 0), B(1, 1), B(2, 1)}, {B(2, 0), B(3, 0), B(2, 1), B(3, 1)} are sequentially selected by incrementing “1 by 1” in the ξ-direction. When the lower-right voxel of the selected small set reaches the right-end of the set of voxels arranged in the plane designated by the user, η is incremented by “1”, and then, the selection continues by incrementing “1 by 1” in the ξ-direction from the left-end to sequentially select {B(0, 1), B(1, 1), B(0, 2), B(1, 2)}, {B(1, 1), B(2, 1), B(1, 2), B(2, 2)}, and so on.

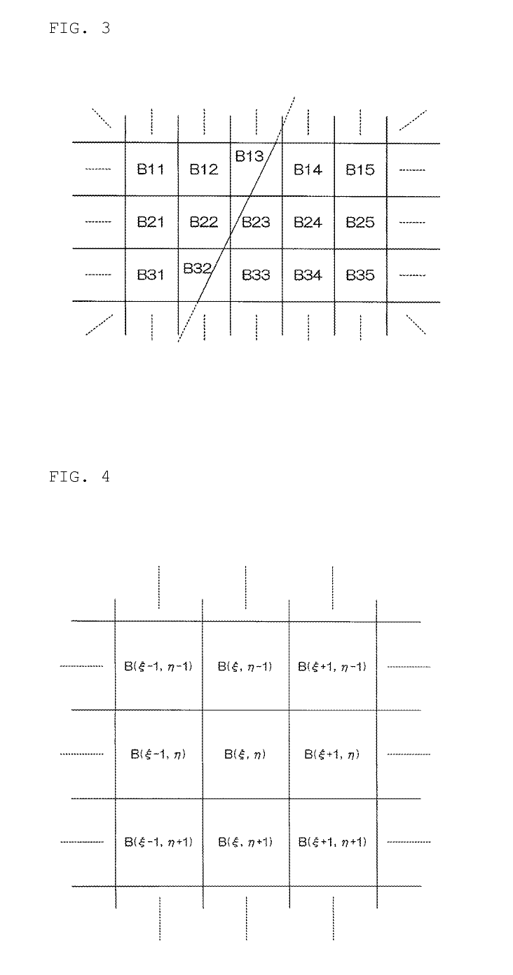

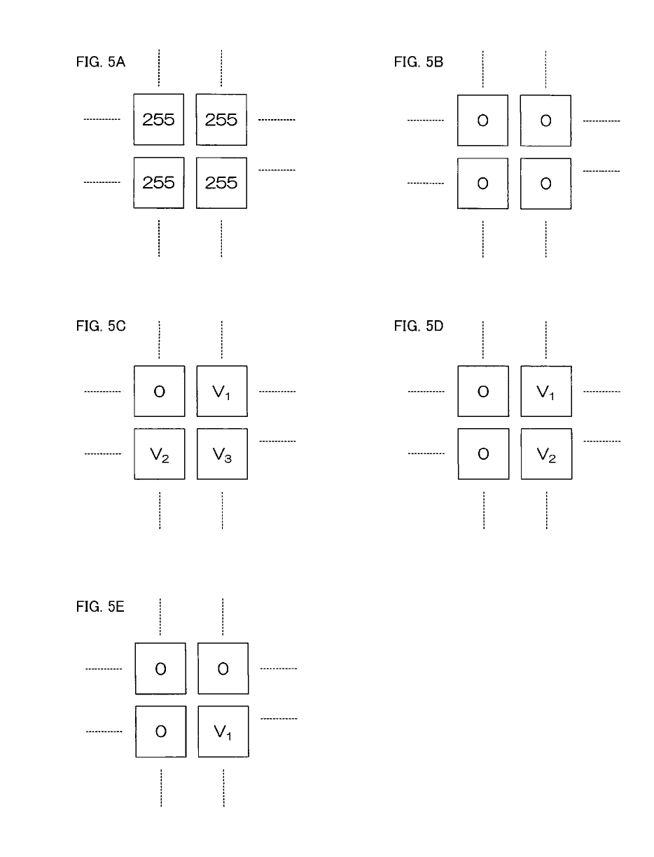

The contour generation unit 25 treats the selected 2×2 voxel data set as a noted set. As exemplified in FIG. 5A to FIG. 5E, the noted set extracted here is (FIG. 5A) all four voxel values within the noted set being Vint, (FIG. 5B) all four voxel values within the noted set being Vext, (FIG. 5C) one voxel value within the noted set being Vext, and other voxel values being other than Vext, (FIG. 5D) two voxel values adjacent in the vertical direction or the lateral direction within the noted set being Vext, and other voxel values being other than Vext, or (FIG. 5E) three voxel values within the noted set being Vext, and other voxel value being other than Vext.

The contour generation unit 25 performs classification of the noted set, as to the above FIG. 5A to FIG. 5E. In case of FIG. 5A all four voxel values within the noted set being Vint, and FIG. 5B all four voxel values within the noted set being Vext, the contour generation unit 25 determines that no boundary of the region of interest is present within the noted set, and performs nothing.

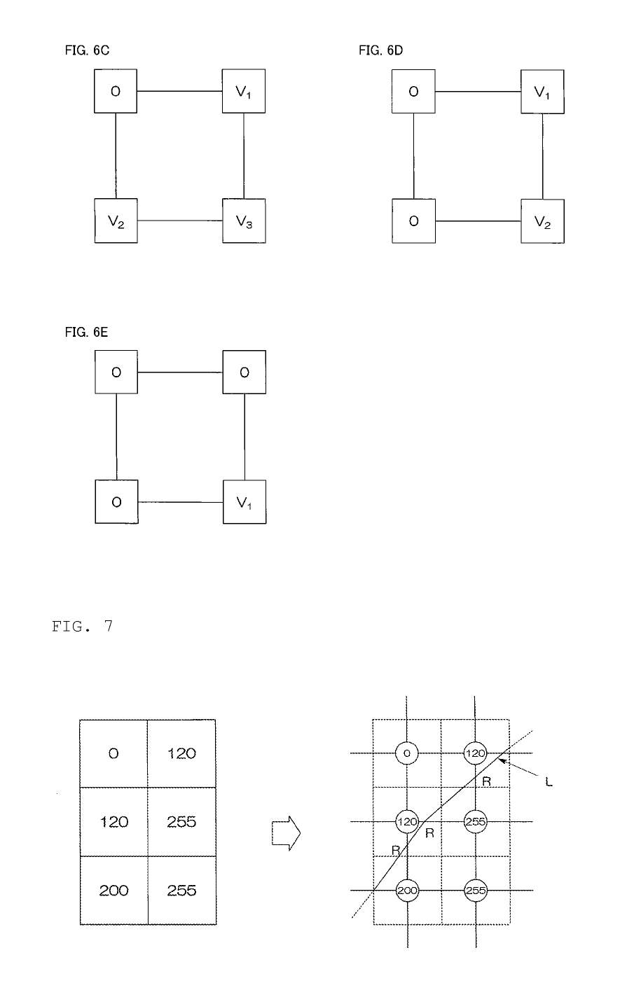

When a noted set includes at least one voxel having a value Vext and at least one voxel having a value other than Vext (in case of any one of FIG. 5C to FIG. 5E above), the contour generation unit 25 sets virtual line segments by mutually connecting the centers of voxels adjacent in the ξ-direction or the η-direction (as shown in FIG. 6C, FIG. 6D, and FIG. 6E, four line segments are formed, defining four sides of a square).

With respect to each of the set line segments, the contour generation unit 25 refers to the voxel values Va, Vb (selected such that Va<Vb is satisfied) of the voxels at opposite ends of the line segment, and examines whether or not Va<Vcenter<Vb is satisfied. Here, Vcenter is an intermediate value, satisfying Vcenter=[(Vint+Vext)/2]. Here, [x] means adopting an integer value closest to and smaller than x. For example, when Vint=255 and Vext=0 are satisfied, Vcenter=[(Vint+Vext)/2] is 127.

When there is a line segment, the voxels at opposite ends thereof having voxel values Va, Vb (selected such that Va<Vb is satisfied), Va<Vcenter<Vb being satisfied, the contour generation unit 25 obtains a coordinate R=Ba+(Vcenter/(Vb-Va))×(Bb−Ba) (R being a coordinate of a three-dimensional point on the XYZ-coordinate), where the center coordinate Ba of the voxel having the voxel value Va, and the center coordinate Bb of the voxel having the voxel value Vb (Ba and Bb being three-dimensional points on the XYZ-coordinate). The point R is a point on the line segment.

Then the point R is obtained with respect to each of two line segments among the line segments set in the noted set (two points R are obtained in the noted set), the contour generation unit 25 defines the line segment connecting the two points R as a contour. The contour generation unit 25 repeats the above processes with respect to each small set selected from each voxel data group within the plane designated by the user. Thereby, the contour generation unit 25 sets a line segment for each voxel data piece through which the contour passes. When line segments are set for adjacent voxel data pieces, the contour generation unit 25 generates a closed curve by connecting the set line segments.

The drawing unit 26 receives information which defines a virtual plane designated by the user in the three-dimensional space. Then, the drawing unit 26 extracts a voxel data group included in the virtual plane, from the image voxel data. Thereby, a sectional plane image when the image voxel data is broken at the virtual plane, can be obtained. The drawing unit 26 outputs and displays the sectional plane image expressed by the extracted voxel group, on the display unit 14.

Further, the drawing unit 26 draws the contour defined by the contour generation unit 25 by superimposing the contour on the displayed sectional plane image. Here, the contour defined by the contour generation unit 25 is included in the virtual plane designated by the user in the three-dimensional space. Also, the contour does not correspond to the boundary of the voxels, but generally corresponds to a line formed by connecting line segments passing through the inside of the voxels. The drawing unit 26 outputs and displays this contour image together with the sectional plane image expressed by the voxels, on the display unit 14

The image generation apparatus according to the present embodiment is constituted as above, and operates as below. The image generation apparatus receives the input of image voxel data in the three-dimensional space, the image voxel data being reconstructed on the basis of a plurality of tomographic images obtained from, for example, a CT (Computed Tomography) image, and stores the received image voxel data in the storage unit 12.

A user designates a plane which intersects the image voxel data in the three-dimensional space, and displays an image expressed by a voxel data group in the image voxel data and arranged on the designated plane. The user designates a two-dimensional region of interest on the displayed image. Designation may be performed by, for example, clicking a plurality of points on the image using a mouse. The image generation apparatus according to the present embodiment forms a closed curve obtained by connecting the plurality of designated points, and sets the region surrounded by the formed closed curve in the designated plane, as a two-dimensional region of interest in the plane. Specifically, the image generation apparatus stores a coordinate value of each designated point in the three-dimensional space.

When the user sets two-dimensional regions of interest in a plurality of designated planes, the image generation apparatus connects the two-dimensional regions of interest set on the respective planes, and forms a three-dimensional region of interest (region defined by boundary planes). Specifically, the image generation apparatus expresses the boundary plane of the three-dimensional region of interest formed by connecting the two-dimensional regions of interest, for example, as a polygon, and stores coordinate information specifying each polygon.

Further, the image generation apparatus generates region-of-interest voxel data having voxels arranged therein, the number and the voxel density of the arranged voxels being the same as those of the voxels in the image voxel data. In the region-of-interest voxel data, the voxel located within the three-dimensional region of interest (on the internal side of the boundary planes) has a voxel value Vint, whereas the voxel located outside of the three-dimensional region of interest has a voxel value Vext, Vext being different from Vint.

Further, in the region-of-interest voxel data, the voxel value of the voxel having the boundary plane of the three-dimensional region of interest passing therethrough, is set between Vext representing the location outside of the three-dimensional region of interest and Vint representing the location within the three-dimensional region of interest, corresponding to the distance from a vertex, located within the three-dimensional region of interest, of the voxel to the boundary plane (when a plurality of vertexes are located within the three-dimensional region of interest, the vertex making the distance maximum is selected). Specifically, with respect to the length r of a line segment connecting the vertexes on the diagonal lines of the voxels and the distance d from the vertexes to the boundary plane, the ratio d/r is obtained, and the voxel value V is calculated to satisfy V=(Vint−Vext)×d/r.

Here, the voxel value of the voxel in the region-of-interest voxel data having the boundary plane of the three-dimensional region of interest passing therethrough, is set on the basis of the distance from the vertex of the relevant voxel to the boundary plane. However, the voxel value can be set on the basis of the volume ratio of the part of the voxel located within the region-of-interest relative to the volume of the relevant voxel.

When the user designates a plane which needs to be displayed (a virtual plane in the three-dimensional space), the image generation apparatus reads out a voxel data group of the image voxel data included in the designated plane, and a voxel data group of the region-of-interest voxel data corresponding to the voxel data group of the image voxel data. Then, the image generation apparatus displays an image expressed by the read-out voxel data group of the image voxel data.

Further, with respect to 2×2 voxel blocks extracted from the read-out region-of-interest voxel data, a block including a voxel having a voxel value other than Vint or Vext (a voxel having the boundary plane passing therethrough, i.e., a boundary voxel) is found. Then, with respect the relevant block, adjacent voxel values Va, Vb (satisfying Va<Vb) are referred to, and whether or not Va<Vcenter<Vb is satisfied, is examined.

Here, Vcenter is an intermediate value, satisfying Vcenter=[(Vint+Vext)/2]. Here, [x] means adopting an integer value closest to and smaller than x. For example, when Vint=255 and Vext=0 are satisfied, Vcenter=[(Vint+Vext)/2] is 127.

When such a combination of voxels is found, the image generation apparatus uses the center coordinate Ba of the voxel having the voxel value Va, and the center coordinate Bb of the voxel having the voxel value Vb (Ba and Bb being three-dimensional points on the XYZ-coordinate), and obtains the following coordinate R.

R=Ba+(Vcenter/(Vb−Va))×(Bb−Ba)

Here, R is a coordinate of a three-dimensional point on the XYZ-coordinate. In an example exemplified in FIG. 7, the voxel values in a 2×2 block are 0, 120, 120, and 255, respectively, and adjacent voxels respectively have voxel values 200 and 255. On the line segments connecting center position coordinates of the respective voxels, the points R are set at positions corresponding to the intermediate values 127, using the voxel values at center positions of the voxels (opposite ends of the line segments) as weights, and the points R are connected.

The image generation apparatus draws a closed curve (in FIG. 7, a portion L thereof is shown) formed by connecting the points R obtained for respective blocks (connecting adjacent points R), so that the closed curve is superimposed on the displayed image.

According to the present embodiment, when a voxel is broken at any selected sectional plane to obtain an image visualizing the region of interest at the selected sectional plane, thanks to the fact that the region of interest is not set on the basis of each voxel, and that the contour is drawn by the line segments passing through the voxels, an image of the region of interest broken at any selected sectional plane can be generated.

For example, when an object is a human body, as far as a contour surrounding an affected region is specified by a predetermined plurality of sectional planes, with respect to an organ imaged by CT, etc., a contour expressing the affected region can be drawn by line segments passing through voxels in the image cut at any selected plane, and thus, the usability can be increased.

1. An image generation apparatus comprising,
an image receiving device which receives image voxel data in a three-dimensional space reconstructed from a plurality of tomographic images,
a designation receiving device which displays an image expressed by voxel data included in the image voxel data and located on a plurality of planes, and receives designation of at least one two-dimensional region of interest on the image,
a device which generates at least one three-dimensional region of interest corresponding to the two-dimensional region of interest in the three-dimensional space, on the basis of each designated two-dimensional region of interest,
a storage device which stores region-of-interest voxel data corresponding to the received image voxel data, and having a voxel value which is made different depending on whether or not the region-of-interest voxel data is included in at least one three-dimensional region of interest,
a contour generation device which receives information defining a plane in the three-dimensional space, reads out the region-of-interest voxel data included in the plane from the storage device, and generates a contour expressing the boundary of the region-of-interest voxel data, and
a drawing device which draws the generated contour together with the image voxel data included in the defined plane.

2. An image generation apparatus according to claim 1, wherein,
a voxel value of the region-of-interest voxel data is set between a value Vext expressing a location outside of the three-dimensional region of interest, and a value Vint expressing a location within the three-dimensional region of interest,
a voxel value of voxel data having adjacent voxel data located outside of the three-dimensional region of interest is set between the value Vext expressing a location outside of the three-dimensional region of interest, and the value Vint expressing a location within the three-dimensional region of interest, corresponding to a distance from the relevant voxel data to the boundary of the three-dimensional region of interest, and
the contour generating device generates a contour by determining a position of the contour expressing the boundary, at the position corresponding to a line segment passing through an intermediate value between the value Vext expressing a location outside of the three-dimensional region of interest, and the value Vint expressing a location within the three-dimensional region of interest, in the image voxel data corresponding to the read-out region-of-interest voxel data.
